(19) United States
(12) Patent Application Publication
(10) Pub. No.: US 2017/0352501 A1
(43) Pub. Date: Dec. 7, 2017

(54) DEVICE FOR OPERATING A SWITCHING DEVICE

(71) Applicant: Eaton Industries (Netherlands) B.V., Hengelo (NL)

(72) Inventors: Dinant Heilersig, Markelo (NL); Pieter Bastiaan Dierselhuis, Enschede (NL)

(21) Appl. No.: 15/536,667

(22) PCT Filed: Dec. 15, 2015
(86) PCT No.: PCT/EP2015/079897

§ 371 Date: Jun. 16, 2017

(30) Foreign Application Priority Data
Dec. 18, 2014 (GB) 1422591.6

(51) Int. Cl. H01H 3/30; H01H 33/666

(52) U.S. Cl. CPC H01H 3/3042; H01H 33/666; H01H 2033/6668; H01H 2033/6667

(57) ABSTRACT

A device for operating a switching device, such as a vacuum interrupter, includes an operating axle for operating the switching device; a driving unit for driving the operation axle; a spring element coupled between the driving unit and the operating axle; and a blocking device for blocking rotation of the operating axle.

### CROSS-REFERENCE TO PRIOR APPLICATIONS

This application is a U.S. National Phase application under 35 U.S.C. §371 of International Application No. PCT/EP2015/079897, filed on Dec. 15, 2015, and claims benefit to British Patent Application No. GB 1422591.6, filed on Dec. 18, 2014. The International Application was published in English on Jun. 23, 2016 as WO 2016/096926 A1 under PCT Article 21(2).

### FIELD

The present invention relates to a device for operating a switching device, such as a vacuum interrupter.

### BACKGROUND

In known motor controlled switching devices or switch gear, a motor drives an operating axle with a crank, which crank is connected to a spring arranged in the switching device. By driving the operating axle, the spring is stretched. When the crank passes the dead center the spring switches the switching device.

For example EP2575153 discloses such an arrangement. These devices cannot switch within a narrow time frame, as it takes time to rotate the operating axle and the dead center at which the internal spring switches the switching device is not clearly defined.

A possibility is to drive the operating axle at a high speed, but this will require larger driving unit and heavier linkages to withstand the higher driving forces.

### SUMMARY

In an embodiment, the present invention provides a device for operating a switching device, such as a vacuum interrupter, the device comprising: an operating axle configured to operate the switching device; a driving unit configured to drive the operation axle; a spring element coupled between the driving unit and the operating axle; and a blocking device configured to block rotation of the operating axle.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 shows a schematic view of a first embodiment of the combination according to the invention.

FIG. 2 shows a schematic view of a second embodiment of a device according to the invention.

### DETAILED DESCRIPTION

In an embodiment, the present invention provides a device that comprises:
an operating axle for operating the switching device;
driving unit for driving the operation axle;
spring element coupled between the driving unit and the operating axle;
blocking device for blocking rotation of the operating axle.

The spring element arranged between the driving unit and the operating axle enable the storage of driving energy in the spring element. By blocking the operating axle just before the dead center at which the internal spring will switch the switching device while letting the driving unit to continue, the spring element will be tensioned. If the spring element are tensioned sufficiently the driving unit are stopped. Now, when the switching device needs to be switched, the blocking device are controlled to release the operating axle, such that the spring energy can be released and the operating axle can be rotated further passed the dead center of the switching device.

Because the operating axle is blocked just before the dead center and because energy is stored in the spring energy, it is possible to switch the switching device in a more narrow time frame, than the prior art, by releasing the operating axle and the energy stored in the spring element.

A preferred embodiment of the invention further comprises a control element for controlling the blocking device between a position blocking the rotation of the operating axle and a position releasing the rotation of the operating axle.

The control element could for example be a solenoid, which can be simply electrically actuated to release the operating axle causing a quick switching of the switching device.

In another preferred embodiment of the device according to the invention the spring element comprise a torsion spring arranged around and with one end to the operating axle and with the other end to the driving unit.

Preferably, the driving unit comprise a gear rotatably arranged on the operating axle and wherein the other end of the torsion spring is arranged to the gear.

The gear can easily be driven by an electric motor and when the operating axle is blocked by the blocking device, further rotating of the gear, will cause the torsion spring to be tensioned. Stopping the electric motor will keep the torsion spring tensioned until the blocking device are released to switch the switching device.

In another embodiment of the device according to the invention the blocking device comprise a groove and pin and a movable blocking part having one of the groove and pin and wherein the operating axle has the other of the groove and pin.

Using a groove and pin provides a reliable blocking mechanism, while it will take little force to take the pin out of the groove to release the operating axle.

The groove can be shaped as a cam like protrusion against which the pin will rest, as the blocking action is only in one rotational direction.

Yet another embodiment of the device according to the invention comprises a gear arranged on the operating axle and a rack engaging on the gear, wherein the driving unit comprise a linear actuator and wherein the spring element are arranged with one end to the rack and with the other end to the linear actuator.

Using a rack and gear provides the possibility for a linear driving of the operating axle. The spring arranged between the rack and the linear actuator ensures, that when the operating axle is blocked, the spring can be tensioned and energy can be stored to be released at the moment the switching device needs to be switched.

Preferably, the blocking device comprise a groove arranged on the rack and a pin movable into engagement with the groove.

As the rack will be moved linearly, a groove in the rack and a pin, which is inserted into the groove provides a simple blocking of the operating axle. Of course it is obvious that the groove in the rack can also be provided as a cam.

The rack could for example also be a split rack with a first rack part connected to the linear actuator and a second rack part arranged by the spring to the first rack part.

The invention also relates to a combination of a device according to the invention and a switching device having at least one movable contact, wherein a transmission is arranged between the operating axle and the movable contact.

In a preferred embodiment of the combination according to the invention the transmission comprises a rod system with a first rod radially extending arranged to the operating axle and a second rod hingedly arranged with one end to the first rod and with the other end to the movable contact.

The rod mechanism of two rods hingedly arranged to each other provides an easy pressure build up for the internal spring of the switching device, by simply rotating the operating axle.

Preferably, the switching device is a vacuum interrupter.

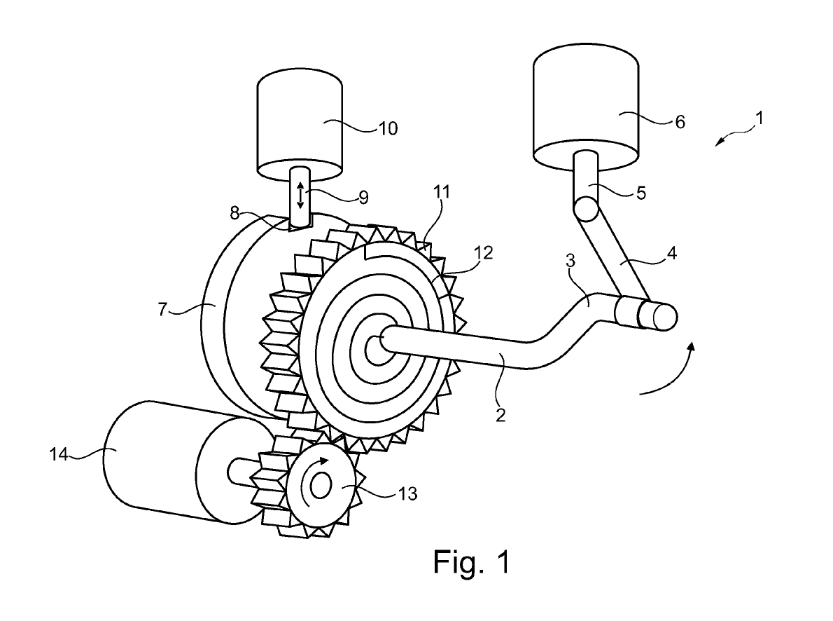

FIG. 1 shows a schematic view of a first embodiment 1 of the combination according to the invention. The embodiment 1 has an operating axle 2 with a crank 3 connected to a mechanism 4. This mechanism 4 in turn is connected to the movable contact rod 5 of a vacuum interrupter 6.

A disc 7 is fixedly arranged on the operating axle 2. This disc 7 has groove 8 in which a pin 9 of a solenoid 10 extends to block rotation of the operating axle 2.

A gear 11 is furthermore provided on the operating axle 2. This gear 11 is for example provided with a bearing, such that it can freely rotate around the operating axle 2.

A torsion spring 12 is arranged between the gear 11 and the operating axle 2, such that the torsion spring 12 can be tensioned by rotating the gear 11, while the operating axle 2 is blocked by the pin 9 of the solenoid 10.

The gear 11 is driven by a second gear 13, which is in turn driven by an electric motor 14.

When the spring 12 is tensioned, the electric motor 14 is stopped, the device 1 is ready to switch the vacuum interrupter by retracting the pin 9 with the solenoid 10. This will cause the spring 12 to unwind and to rotate the operating axle 2 further and moving the axle 2 passed the dead center, which will close the vacuum interrupter 6.

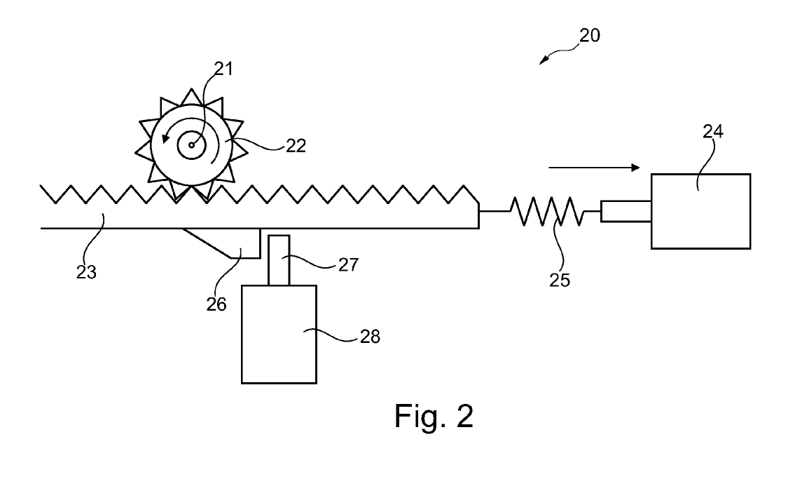

FIG. 2 shows a schematic view of a second embodiment of a device 20 according to the invention. This device 20 has an operating axle 21 connected via a suitable mechanism to a switching device. A gear 22 is arranged on the operating axle 21 which engages on a rack 23.

The rack 23 is linearly moved by an actuator 24, which is connected to the rack 23 via a spring 25. The rack 23 has a pin 26 at the bottom, which is engaged by a pin 27 of a solenoid 28, such that the rack cannot be moved further. A tension is provided in the spring 25, when the actuator 24 is moved further, while the rack 23 is blocked by the pin 27.

Now when the pin 27 is retracted, the rack 23 will be released and pulled to the right by the tensioned spring 25, such that the operating axle 21 is rotated further and a switching device is moved passed the dead center.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for operating a switching device, such as a vacuum interrupter, the device comprising:
an operating axle configured to operate the switching device;
a driving unit configured to drive the operation axle;
a spring element coupled between the driving unit and the operating axle; and
a blocking device configured to block rotation of the operating axle.

2. The device according to claim 1, further comprising a control element configured to control the blocking device between a position blocking the rotation of the operating axle and a position releasing the rotation of the operating axle.

3. The device according to claim 1, wherein the spring element comprises a torsion spring arranged around and with one end to the operating axle and with the other end to the driving unit.

4. The device according to claim 3, wherein the driving unit comprises a gear rotatably arranged on the operating axle, and wherein the other end of the torsion spring is arranged to the gear.

5. The device according to claim 1, wherein the blocking device comprises a groove and pin and a movable blocking part having one of the groove and pin, and wherein the operating axle has the other of the groove and pin.

6. The device according to claim 1, further comprising a gear arranged on the operating axle and a rack engaging the gear, wherein the driving unit comprises a linear actuator, and wherein the spring element is arranged with one end to the rack and with the other end to the linear actuator.

7. The device according to claim 6, wherein the blocking device comprises a groove arranged on the rack and a pin movable into engagement with the groove.

8. A combination of the device according to claim 1 and a switching device having at least one movable contact, wherein a transmission is arranged between the operating axle and the movable contact.

9. The combination according to claim 8, wherein the transmission comprises a rod system with a first rod radially extending arranged to the operating axle and a second rod hingedly arranged with one end to the first rod and with the other end to the movable contact.

10. The combination according to claim 8, wherein the switching device comprises a vacuum interrupter.
